(19) United States
(12) Patent Application Publication
(10) Pub. No.: US 2020/0110842 A1
(43) Pub. Date: Apr. 9, 2020

(54) TECHNIQUES TO PROCESS SEARCH QUERIES AND PERFORM CONTEXTUAL SEARCHES

(71) Applicant: Capital One Services, LLC, McLean, VA (US)

(72) Inventors: Koon Heng Ivan TEO, San Francisco, CA (US); Fernando SAN MARTIN JORQUERA, Los Altos, CA (US); Mohammad SHAMI, Foster City, CA (US)

(73) Assignee: Capital One Services, LLC, McLean, VA (US)

(21) Appl. No.: 16/150,783

(22) Filed: Oct. 3, 2018

(51) Int. Cl. G06F 17/30; G06F 15/18

(52) U.S. Cl. CPC G06F 17/30867; G06F 17/30979; G06F 15/18; G06F 17/30991; G06F 17/30967

(57) ABSTRACT

Various embodiments are generally directed to techniques to determine contextual search terms. For example, embodiments include receiving a search query including a search term, the search query to cause performance of a search within a website. Embodiments also include determining a rule comprising one or more criteria is met, the rule associated with the search term and to link the search term with a contextual search term when the one or more criteria are met, appending the contextual search term with the search term in the search query to perform the search within the website, and performing the search within the website utilizing the search query comprising the search term and the contextual search term. Finally, embodiments include returning a result to the website.

### BACKGROUND

Information retrieval systems, such website search engines, help users by retrieving information, such as web pages, images, text documents and multimedia content, in response to search queries. A search engine may locate information and data relating to the search query and return a result to the user. Formulating a search query that accurately represents the user's informational need can be challenging. For example, users may use query terms which are too general or ambiguous to yield high-quality search results. Thus, the search engine may return results which match the user's query, but which are unrelated to the informational need of the user. In such a case, the user may have to enter a number of different queries about the same topic before reaching results that are of interest to the user. Refining the search can be a time-consuming and frustrating experience for the user.

### BRIEF DESCRIPTION OF THE DRAWINGS

FIG. 1 illustrates an example of a search system to process search queries.

FIG. 2A illustrates an example of a first processing flow for a search query.

FIG. 2B illustrates an example of a second processing flow for a search query.

FIG. 3 illustrate example of a first logic flow to process a search query.

FIG. 4A illustrates an example of a storage capable of storing a dictionary.

FIG. 4B illustrates an example of a storage capable of storing rules.

FIG. 5A illustrates an example of a second logic flow.

FIG. 5B illustrates an example of a third logic flow.

FIG. 5C illustrates an example of a fourth logic flow.

FIG. 6 illustrates an embodiment of a computing architecture.

FIG. 7 illustrates an embodiment of a communications architecture.

FIG. 8 illustrates an example processing flow to perform machine-learning operations.

### DETAILED DESCRIPTION

Various embodiments are generally directed to techniques to refine search queries including determining contextual search terms based on the search query and a user context to provide more accurate results while reducing the number of times a user must refine their search. Moreover, embodiments discussed herein enhance a search engine with the capabilities of intelligently returning documents, webpages, information, etc. relevant to a user's context. Thus, embodiments provide a personalized experience and reduce the amount of time and effort expended to locate the desired information.

Previous solutions include utilizing supplemental terms based on content in a display document when receiving a search query, see, e.g., U.S. Pat. No. 9,342,601, searching based on qualities of an item, see, e.g., U.S. Pat. No. 6,847,963, and performing a search based on contextual information received via a sensor coupled via a wireless link, see, e.g., U.S. Pat. No. 7,289,806. However, embodiments discussed herein differ from previous solutions and are advantageous in that they provide a more personal experience while determining contextual search terms by utilizing personalized rules to link terms. Additional advantages include determining the contextual search terms and returning more accurate results based on the personalization of the contextual search terms.

In one example, a search query may be related to digital banking, and the user's context includes information, such as account type, account ownership, transaction data, external events affecting a user's account (e.g., lost/stolen cards), etc. In embodiments, each user's context may be extracted from data and translated into keywords or contextual search terms that may be appended to a submitted search term of the search query. Thus, documents, information, etc. returned by the search query is more relevant to a user's context.

In embodiments, a dictionary of common search terms may be compiled using one or more analysis discussed herein, e.g., leveraging a pre-built thesaurus, using natural-language processing, etc. and links can be defined between the terms of the dictionary. For example, two terms may co-occur frequently and/or have a strong semantic relationship, e.g., fee and overdraft. Further, a ‘context trigger’ may be utilized to enable a link between the terms. The ‘context trigger’ may be a rule having criteria that when met enables the link between the terms. The rule may be associated with a user and may personalize the contextual search results. In one specific example, the rule for a link between fees and overlimit may be whether the user has been assessed an overlimit fee on the account or if the account is close to overlimit status. Thus, in this case, when the user searches for ‘fees’ the rule enables a link between ‘overlimit’ and ‘fees’ and adds ‘overlimit’ to the search query. In this example, information pertaining to overlimit fees is returned to the user and presented first on a display. These and other details will become more apparent in the following description.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

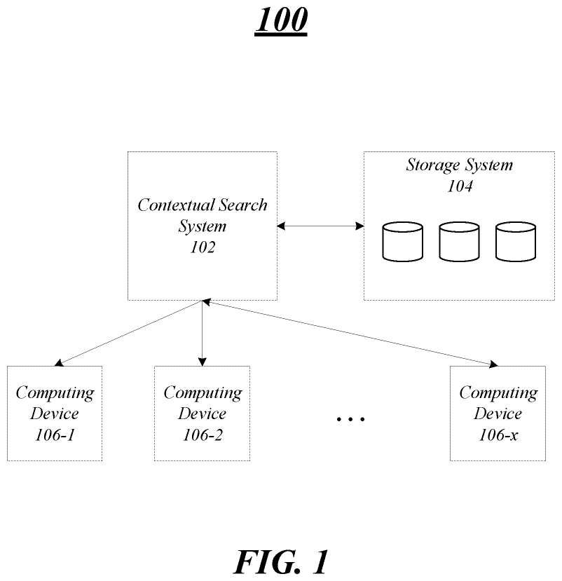

FIG. 1 illustrates an example of search processing system 100 that is capable of processing search queries and determine contextual search terms to increase the likelihood of a successful search result. In embodiments, the search processing system 100 includes a number of components, systems, and devices, such as one or more computing device 106-x, where x may be any positive integer, a contextual search system 102 and a storage system 104. The computing device(s) 106 may be any type of device, such as a desktop computer, a mobile computing device, a server, a terminal device, and so forth. The computing devices 106, contextual search systems 102, and storage system 104 may be coupled via one or more network links, including wired and wireless network links. In embodiments, the network links may be part of one or more networking system, such as the Internet, and include additional processing and communication devices. Embodiments are not limited in this manner.

In embodiments, the search processing system 100 may perform a number of operations to perform a search query to search a website including one or more webpages for particular content and information. In embodiments, the processing system 100 including the contextual search system 102 may include a “search engine” or a software system that is designed to search a particular website or websites for information and return a result to a user a computing device 106, for example. In some embodiments discussed herein, the website search may be localized to a particular website and the content within the website on the website's pages. For example, a search query may be for particular content on the website www.capitalone.com. However, embodiments are not limited in this manner and may apply to any website and/or combination of websites.

The search processing system 100 including the contextual search system 102 may receive a search query including one or more search terms. The search query may be generated by a user at a computing device 106 and sent to the contextual search system 102 via one or more network links. In embodiments, the contextual search system 102 may include processing circuitry, memory, storage, a network interface, and so forth to process data including search queries. In some instances, the contextual search system 102 may include computing system architecture including a number of servers capable of processing data. These servers may be in a same location or in a different location, e.g., a distributed and/or cloud-based computing system. Embodiments are not limited in this manner.

In embodiments, the contextual search system 102 may receive a search query including one or more search terms and determine one or more contextual search terms relating to the one or more search terms, e.g., typically found together in the website and or in a document. The contextual search system 102 may utilize a dictionary of related terms and rules to determine a contextual term for a search term. The dictionary may store terms and its related terms. The related terms may be determined by the contextual search system 102 to populate the dictionary which may be stored in a database of the storage system 104. In one example, the contextual search system 102 may determine user context for each user account by performing a scrape or a crawl through a database. The user context may be a type of account for the user, e.g., credit card account, checking account, savings account, loan account, and so forth. Another user context for a user account may include a status of the account (default, overdue, etc.), a balance (or no balance) for the account, transaction data, external events (lost/stolen credit card), internal events, and so forth. The user context may be determined by the contextual search system 102 by extracting information from available user data in the user account database that may be stored in the storage system 104 and applying a computing analysis, e.g., leveraging a thesaurus to determine related terms, and applying natural language processing. For example, the contextual search system 102 may use lexical semantics to determine individual words in context.

In one example, the contextual search system 102 may determine terms from call transcript data based on user-made customer service calls. Transcripts of calls made by the user to the company can be analyzed to pick out context-relevant topics, e.g., a customer calling to enquire about the company's small business card offerings would have “small business” added to any product searches made by the customer. In this example, the presence of a given topic within the transcript acts as a context trigger or rule for the link between “small business” and product-related search terms like “card” and “offerings”. The identification of such topics may be performed through a topic model trained on the large amount of historical call transcript data that the company has accumulated over years.

In another example, the contextual search system 102 may map entered search terms to synonyms or near-synonyms that are more specific to the documents to be searched. Embodiments include training a model on call transcripts and prior web searches (user search query+content of document that the user ultimately picks) to identify sets of terms that are semantically similar, such as “interest” and “APR”. In one example, neural network algorithms for word embeddings may be used for training the model. Terms that are semantically similar may not have the same level of relevance. In the “interest” example, other semantically similar terms that are more specific include “APR” and “mortgage interest”. The customer's context, supposing for example that the customer owns a card product, would cause the term “APR” to be included in the query by virtue of a pre-defined link between “card” and “APR”. The search would thereby include documents that exclusively use “APR” in place of “interest”. Embodiments are not limited to these examples.

The related terms may be linked to search terms based on whether a rule is met. A rule may include one or more criteria or stipulations that must be true to create a link between two terms, e.g., a search term and a contextual term. In one example, the contextual search system 102 may submit a query to the storage system 104 that may have one or more databases including a dictionary database storing the dictionary to determine related terms. The contextual search system 102 may receive a result including the related terms from the storage system 104 based on the query. In one example, the result may indicate all possible related terms for the search term. The contextual search system 102 may then apply one or more rules to the result of the query to the dictionary database to determine whether a link exists between the terms, e.g., the search term and a related term returned in the result.

In embodiments, the contextual search system 102 may utilize the related terms as a contextual search term with the received search term to perform a search on the website and return a result to the requesting computing device 106 and user. In some instances, the contextual search system 102 may determine a number of contextual search terms for a received search term and return the contextual search terms to the requesting computing device 106 for presentation to a user. The contextual search system 102 may receive a selection of one of the contextual search terms presented to the user and utilize the selected contextual search term with the originally received search term to perform a search. In another example, the contextual search system 102 may determine a ‘best’ contextual search term related to the received search term based on one or more factors, e.g., related term most found with search term (frequency of appearance in the website or document), historical searches performed by the user, historical searches performed by other users, and so forth.

In some instances, the contextual search system 102 utilizes rules to determine links between search terms and related terms based on an associated user account. For example, each user account may be associated with its own set of rules based on the user context of the user account. Thus, the contextual search system 102 may apply one or more rules relating to a user account to the terms returned based on the query to the dictionary database. The contextual search system 102 may determine rules associated with a user based on the user being logged into the user account when performing the search and/or the user providing the account information for the user account to perform the search. In embodiments, the contextual search system 102 may perform a look up in the storage system 104 to determine associated rules using the user account. More specifically, the storage system 104 may include one or more databases including a rules database that associates user accounts with rules. The contextual search system 102 may submit a query including the user account to the storage system 104 to determine the rules and receive a result including the rules from the storage system 104.

In one specific example, the search processing system 100 may be incorporated in a digital banking system. A dictionary of common search terms and related terms may be compiled by the contextual search system 102 and stored in the storage system 104 based on a user context and leveraging a thesaurus and/or natural language processing. The user context in this example may be an account type ownership, transaction data, external events affecting the user account, and so forth. The search terms and related terms may co-occur frequently and/or have a strong semantic relationship, e.g., fees and overlimit. A rule may be applied to the terms (search term and related term) as a context trigger that when met causes a link between the terms. The rule may include one or more criteria or conditions that when met determines that the terms become relevant to a user. For example, the rule or context trigger for the link between fees and overlimit may be whether the user has been assessed an overlimit fee or if the account is close to overlimit status. Thus, when a user enters ‘fees’ the contextual search system 102 retrieves related terms including ‘overlimit’ from the dictionary database. The contextual search system 102 may then determine rules associated with the user account and apply the rules to the term ‘fee’ and the returned related terms. In this example, the rule that a user account has been assessed an overlimit fee is met; and therefore, a link between those terms (fee and overlimit) is established. The contextual search system 102 may utilize the term (fee) and the related and linked term (overlimit) to perform a search on the website.

In some embodiments, the contextual search system 102 may perform one or more operations to determine related terms on a periodic, semi-periodic, and/or non-periodic basis to generate and update the dictionary. For example, the contextual search system 102 may perform a crawl or scrape operation on a periodic basis, e.g., daily, weekly, month, etc., to generate and update the related terms in the dictionary. The scrape or crawl operation may include performing analysis on an associated website and utilizing one or more a thesaurus and/or natural language processing techniques to determine the related terms that may be present on the website. For example, the contextual search system 102 may determine terms present in the website and run the terms through a thesaurus to determine synonyms or words related to terms present in the website. In another example, the contextual search system 102 may apply a natural language processing technique to determine words that typically appear together within the website to determine related terms. The contextual search system 102 may use the results of these analyses to update the dictionary that is stored in a dictionary database of the storage system 104, for example.

The contextual search system 102 may also perform one or more operations to generate rules. For example, the contextual search system 102 may apply machine-learning processing to determine scenarios that are present and relevant to related terms, e.g., account over drafted typically means that an overdraft fee is applied. Thus, a rule may be when the account is over drafted link the terms overdraft and fee. The machine-learning techniques may include performing one or more training operations to generate results including the rules. These training operations may include running one or more known data sets through machine-learning. Based on the result of the contextual search system 102 performing the machine-learning techniques, the contextual search system 102 may update one or more rules in the rules database in the storage system 104, for example.

In some embodiments, the contextual search system 102 may perform machine-learning operations for each user account to determine/generate rules for each of the user accounts. In some embodiments, the contextual search system 102 may use data associated with each user account to run through the machine-learning operations to determine rules for each user account. Embodiments are not limited in this manner.

In another example, the one or more contextual search system 102 may enable a user to enter the one or more rules. For example, the contextual search system 102 includes a terminal (display device) and input devices (mouse and keyboard) to enable a user or administrator to enter the rules.

The storage system 104 may store the data and information relating to the contextual search system 102 and performing contextual search operations, e.g., a plurality of user accounts, a plurality of rules, a plurality of search terms, and a plurality of contextual search terms or related terms. As mentioned, the storage system 104 may include a number of databases, e.g., a user account database, a rules database, and a terms database. The databases may be any type of database, e.g., a rationale database, entity-relationship database, object model database, document model database, flat file system, and so forth.

The storage system 104 may include a number of storage devices, e.g., hard drives, capable of storing the data and information. Note that in some embodiments, the storage system 104 may co-locate the data and information in a specific location or in different locations. Embodiments are not limited in this manner.

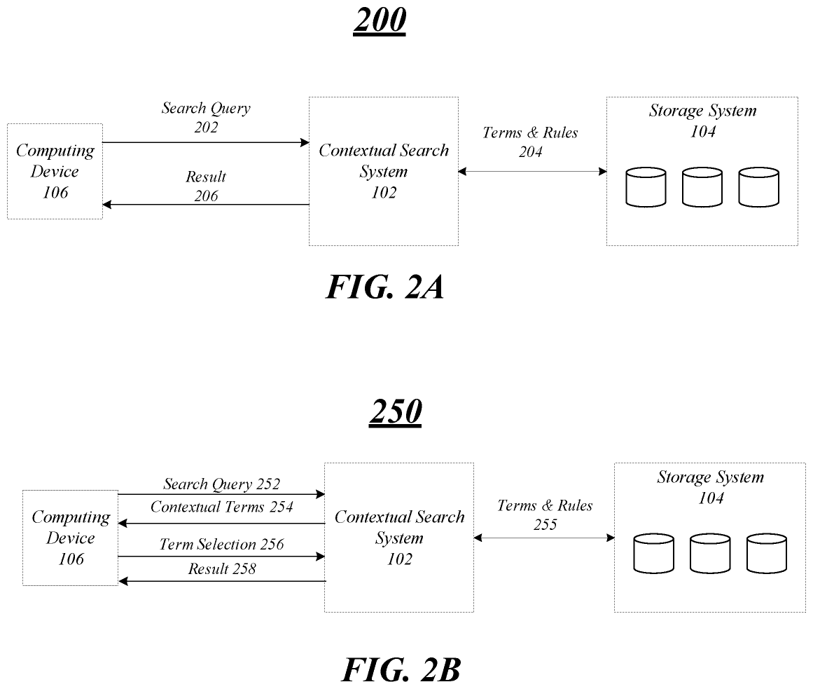

FIG. 2A illustrates an example of a processing flow 200 to process a search query. The illustrated example includes one or more communications and operations that may be performed by a search processing system 100 include a computing device 106, a contextual search system 102, and a storage system 104.

In embodiments, the computing device 106 may receive a request to perform a search query on a website. The request may be received based on one or more inputs entered by a user of the computing device 106. In one example, the user may be logged into a user account associated with the website, and the user may enter the search query in a search field presented on a display device displaying a webpage of a website. The user may enter the search query, which may include one or more search terms, and the computing device 106 may send the search query at line 202 to the contextual search system 102. The contextual search system 102 may be part of a search processing system associated with the website to perform a search and return results.

The contextual search system 102 may determine additional and/or contextual search terms for the search terms of the search query. As previously discussed, the contextual search system 102 may process the search query including the one or more search terms to determine related or contextual search terms for the received search terms. More specifically, the contextual search system 102 may perform operations with a dictionary including terms (search terms) and related terms (contextual search terms) to determine the contextual search terms for the received search terms. The contextual search system 102 may submit a query to the dictionary, which may be stored in a dictionary database, including the one or more search terms to retrieve related or contextual search terms at line 204. In this example, the storage system 104 includes the dictionary database may return a result including a single contextual search term at line 204. However, as will be discussed in more detail below, the storage system 104 may return any number of contextual search terms in response to a query from the contextual search system 102.

The contextual search system 102 may also determine one or more rules that may be applied to the returned contextual search terms at line 204. For example, the contextual search system 102 may submit a query to the storage system 104 to retrieve rules associated with a user account for the user of computing device 106. The storage system 104 may process the query including determining one or more rules associated with the user account and send a result to the query to the contextual search system 102. The result may include the rules associated with the user account. The storage system 104 may determine the rules stored in a rules database of the storage system 104. Note that embodiments are not limited in this manner. In some instances, the storage system storing rules may be different than the storage system storing the dictionary.

The contextual search system 102 may apply the rules to the returned contextual search terms to determine whether any links exist between the returned contextual search terms and the received search term from the computing device 106. As previously discussed, a rule may include one or more criteria or stipulations that must be satisfied for a link to be generated between terms.

In this example, the contextual search system 102 may determine a single contextual search term is linked to the received search term and determine to perform a search utilizing the search term and the contextual search term. Note that if the contextual search system 102 determines that no contextual search terms exist for the received search term, the contextual search system 102 may perform a search based on the received search term.

In embodiments, the contextual search system 102 may receive and/or determine the results of the search and may return the results to the computing device at line 206.

FIG. 2B illustrates an example of a processing flow 250 to process a search query. The illustrated example includes one or more communications and operations that may be performed by a search processing system 100 include a computing device 106, a contextual search system 102, and a storage system 104.

In embodiments, the computing device 106 may receive a request to perform a search query on a website. For example, a user may enter the search query, which may include one or more search terms, and the computing device 106 may send the search query, at line 252, to the contextual search system 102. The contextual search system 102 may be part of a search processing system associated with the website to perform a search based on the search query and return results.

The contextual search system 102 may determine additional and/or contextual search terms for the search terms of the search query. As previously discussed, the contextual search system 102 may process the search query including the one or more search terms to determine related or contextual search terms for the received search terms. At line 255, the contextual search system 102 may interact with the storage system to determine contextual search terms and rules related to the user account for the search query. In this example, the storage system 104 includes the dictionary database and may return a result including multiple contextual search term at line 255. The contextual search system 102 may apply the one or more rules to the returned contextual search terms. In this example, the contextual search system 102 may determine that a number of links exist between the received search terms and the contextual search terms. In embodiments, the contextual search system 102 may determine the ‘best’ contextual search term, as previously discussed, and perform the search using the search term and the ‘best’ contextual search term.

However, in this example, the contextual search system 102 may return the contextual search terms to the computing device 106 at line 254 to enable a user to select one of the contextual search terms. For example, a user of computing device 106 may be presented with a display, drop down menu, list, etc. including the contextual search terms. The user may utilize an input device to select one of the contextual search terms which may be returned to the contextual search system 102 at line 256 as a selected contextual search term.

The contextual search system 102 may apply the rules to the returned contextual search terms to determine whether any links exist between the returned contextual search terms and the received search term from the computing device 106. As previously discussed, a rule may include one or more criteria or stipulations that must be satisfied for a link to be generated between terms. In this example, the contextual search system 102 may perform a search utilizing the search term and the contextual search term selected by the user. The contextual search system 102 may receive and/or determine the results of the search and may return the results to the computing device at line 258.

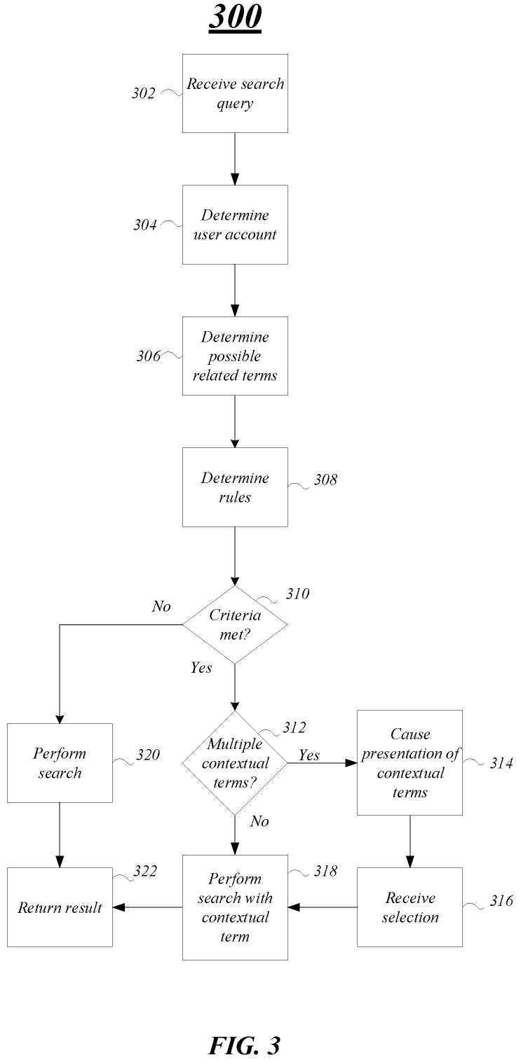

FIG. 3 illustrates an example of a first logic flow 300 that may be representative of some or all of the operations executed by one or more embodiments described herein. For example, the logic flow 300 may illustrate operations performed by a search processing system to process a search query. More specifically, FIG. 3 illustrates operations that may be performed by a contextual search system 102, as illustrated in FIG. 1 and FIGS. 2A/2B.

In embodiments, the contextual search system 102 may receive a search query to perform a search on a website. The request may be received based on one or more inputs entered by a user of a computing device 106. The search query may include one or more search terms, e.g., words submitted to search the website. In embodiments, the contextual search system 102 may also receive information identifying a user account associated with the search query. At block 304, the contextual search system 102 may determine the user account associated with search query based on the information. In some instances, the contextual search system 102 may receive a search query and an identifier (username/password) associated with the user account. In one example, the contextual search system 102 may use a username to perform a lookup in a database, e.g., a user account database in storage system 104, to determine a user account and information relating to the user account, e.g., status of account, type of account, personal information, transaction history, etc. Embodiments are not limited in this manner and may include the contextual search system utilizing other methods to determine an associated user account, e.g., cookies, logged into an account, etc.

At block 306, the contextual search system 102 may determine one or more term related to the one or more search terms of the search query. For example, the contextual search system 102 may make a query to a dictionary database of the storage system 104 to retrieve the related terms. The query may include the one or more search terms from the search query and may be used to perform a look up in the dictionary database. The contextual search system 102 may receive the related terms based on the query. Note that in some embodiments, the dictionary may be stored differently, e.g., a flat file system, cloud-based storage system, etc. and may be local or remote to the contextual search system 102.

At block 308, the contextual search system 102 may determine one or more rules for the search query. For example, the contextual search system 102 may submit a query to a rules database to determine one or more rules that may be associated with the user of the system. In embodiments, the query may include user identification information, e.g., an identification of the user account, an email address, or some other identifier. In some instances, the contextual search system 102 may determine an index value associated with the user account and submit the query with an index. The contextual search system 102 may receive results of the query, which includes the one or more rules associated with the user account.

In embodiments, the one or more rules specify one or more criteria or stipulations that must be met to link a related term with a search term, e.g., generating a contextual search term, that may be used to perform the search with the submitted search terms. At block 310, the contextual search system 102 may determine whether the one or more criteria of each of the one or more rules are met. The determination may be based on information and data relating to the user account, the user, and so forth. For example, the determination may be based on a status of the user account, a type of the user account, transaction information relating to the user account, personal information (location, phone number, address, date of birth, social security number (SSN)), rewards for the account, points for the account, special offers for the account (balance transfers), travel information, and so forth.

In embodiments, the contextual search system 102 may determine that none of the criteria for any of the rules is met; and therefore, links are created to generate contextual search terms. In this case, the contextual search system 102 may perform the search of the website using the search terms of the search query at block 320. In other instances, the contextual search system 102 may determine that at least one rule is met, e.g., the one or more criteria for the at least one rule is met.

At block 312, the contextual search system 102 may determine whether more than one rule is met, e.g., generating more than one contextual search terms by establishing links between search terms and related terms. If one rule is met creating a single contextual search term, the contextual search system 102 may append the contextual search term to the search term(s) of the search query and perform the search at block 318. If the contextual search system 102 determines that more than one contextual search term exists, the contextual search system 102 may determine how to process the additional contextual search terms. In one example illustrated in FIG. 3, the contextual search system 102 may cause presentation of the multiple contextual search terms on a display device for a user at block 314. Note that in other instances, the contextual search system 102 may determine to proceed with the search with all of the contextual search terms and the search terms of the search query. In another example, the contextual search system 102 may choose the ‘best’ contextual search term, as previously discussed.

At block 316, the contextual search system 102 may receive a selection of a contextual search term when the contextual search terms are presented to the user. Further and at block 318, the contextual search system 102 may perform the search utilizing the selected contextual search term appended to the received search terms at block 318. At block 322, the contextual search system 102 may return the results of the search to the user device 106 from which the search query is received. Note that embodiments are not limited in the manner as illustrated in FIG. 3. For example, one or more operations or blocks may occur before or after other blocks, e.g., the contextual search system 102 may first determine the rules associated with the user account and then determine the possible related terms.

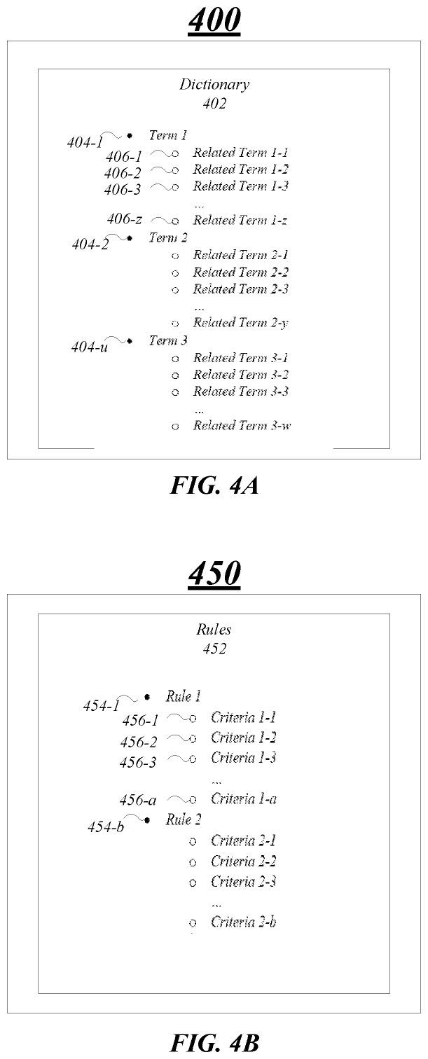

FIG. 4A illustrates a first example of a storage 400 to store a dictionary 402. In embodiments, the storage 400 may include a data structure, such as a database to store the dictionary 402. The storage 400 may be any type of storage device as discussed herein, e.g., a non-volatile storage, memory, HDD, computer-readable storage medium, non-volatile computer readable storage medium. Embodiments are not limited in this manner. Moreover, the database may be any type of database including, but not limited to, a rationale database, object-oriented database, non-rationale database (NoSQL), hierarchical database, network database, cloud database, and so forth.

In embodiments, the storage 400 may include the dictionary 402 which may have one or more terms 404-1 through 404-u, where u may be positive integer. Each of terms 404 may be associated with one or more related terms 406-1 through 406-z, where z is any positive integer. The related terms 406 may be related to the terms 404 based on one or more analysis, e.g., natural language processing, thesaurus analysis, word association analysis, etc. For example, one or more operations may be run on a website, e.g., a crawl or scrape, where one or more of the analysis are applied to determine terms and related terms. More specifically, an operation may be run on a website where a website including the website content is analyzed by natural language processing to determine words that are related, e.g., contextual. In another example, an operation may be run on website and content and a thesaurus may be used to determine related terms related to the terms (content) of the website. In a third example, an operation may be run on a website and content and terms deemed close to each other (within 3 words) may be considered related terms. In another example, a user or administrator may determine terms and related terms, e.g., user defined. In another example, an operation may include performing machine learning utilizing historical information, e.g., past searches, to determine related terms. Embodiments are not limited to these examples.

The one or more operations to determine related terms may be performed on a periodic, non-periodic, or semi-periodic basis, e.g., daily. In some instances, the frequency of performing the one or more operations may be set by a user or an administrator.

FIG. 4B illustrates a second example of a storage 450 to store rules database (storage) 452. In embodiments, the storage 450 may include a data structure, such as a database to store the dictionary 452. The storage 450 may be any type of storage device as discussed herein, e.g., a non-volatile storage, memory, HDD, computer-readable storage medium, non-volatile computer-readable storage medium. Embodiments are not limited in this manner. Moreover, the database may be any type of database including, but not limited to, a rationale database, object-oriented database, non-rationale database (NoSQL), hierarchical database, network database, cloud database, and so forth.

In embodiments, the storage 450 may include one or more rules 454-1 through 454-b, where b is any positive integer. Each of the one or more determined rules 454 may include one or more criteria 456-1 through 456-a, where a may be any positive integer. A rule 454 including one or more criteria 456 may be met and used to establish a link. In embodiments, a rule 454 may establish a link between a term and a related term and the related term may be considered a contextual search term. Thus, when a search term is received as a search query, operations may include using the rules 454 to determine whether one or more criteria 456 is met generating a link between the term (search term) and a related term. In some embodiments, one or more of the rules 454 may be associated with users. Thus, each user may be associated with their own ‘set’ of rules 454. A user login or account information may be used to determine which rules 454 to utilize when analyzing a search term.

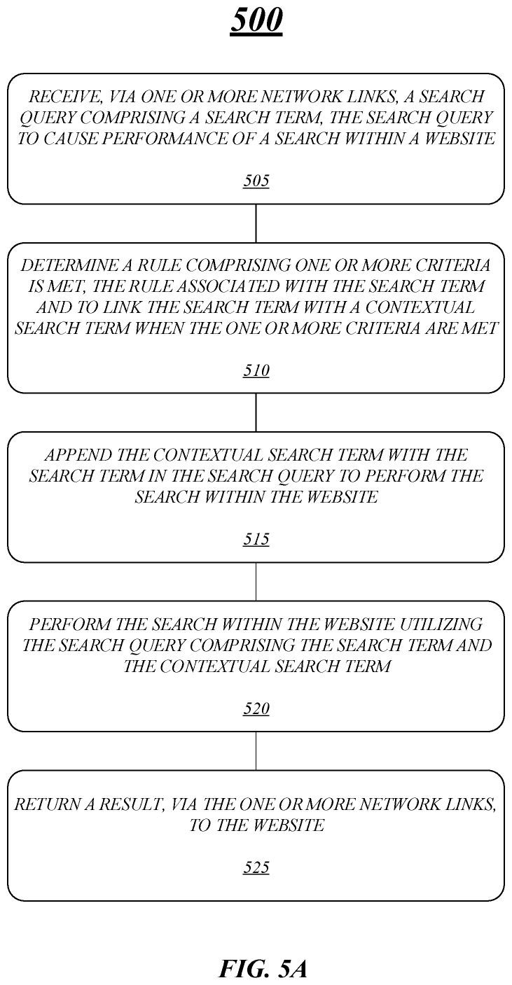

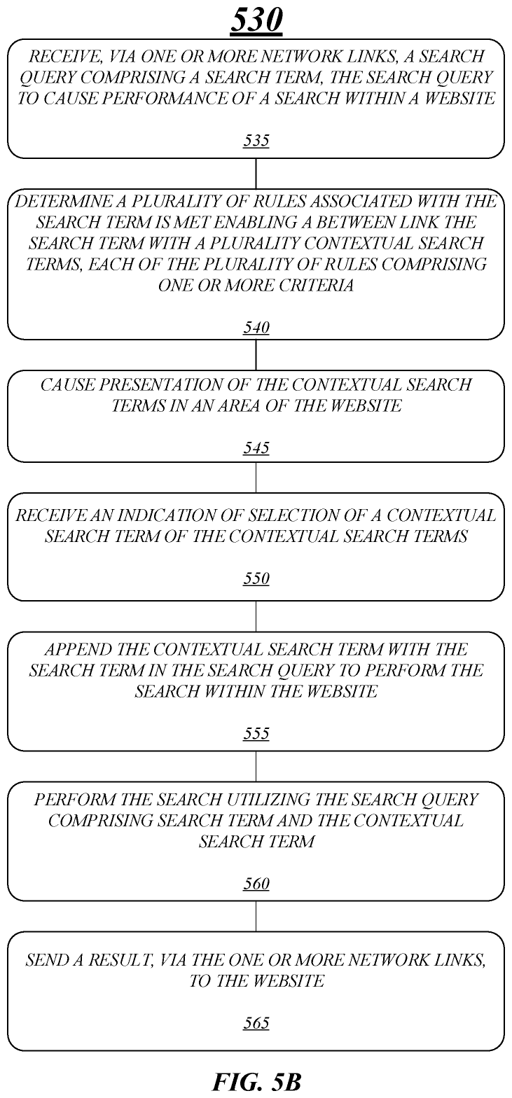

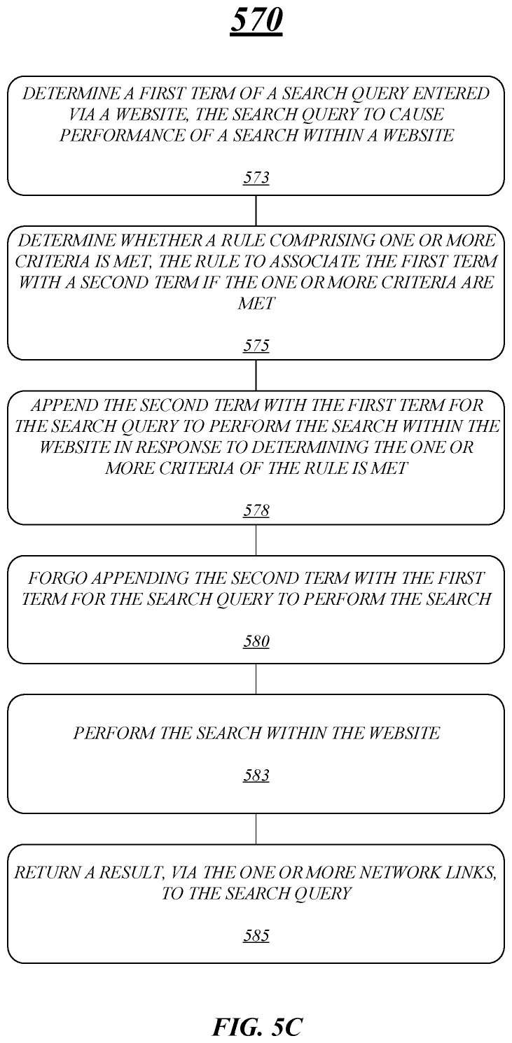

FIG. 5A illustrates an example of a second logic flow 500 to determine contextual search terms for received search terms. FIG. 5A illustrates an example of a logic flow 500 that may be representative of some or all of the operations executed by one or more embodiments described herein.

At block 505, the logic flow 500 includes receiving a search query including a search term. In embodiments, the search query may be submitted by a user of a computing device communicated to a server or system. The search query may cause performance of a search within a website and may be used to determine contextual search terms to perform the search.

The logic flow 500 includes determining a rule comprising one or more criteria are met, the rule associated with the search term and to link the search term with a contextual search term when the one or more criteria are met at block 510. Further and at block 515, the logic flow 500 includes appending the contextual search term with the search term in the search query to perform the search within the website. Thus, the search may provide better results sooner by adding the contextual search terms to quickly return a search.

At block 515, the logic flow 500 includes performing the search within the website utilizing the search query comprising the search term and the contextual search term. And at block 520, the logic flow 500 includes returning a result to the website. The result may be information, data, webpages, etc. relating to the search query and based on the search.

FIG. 5B illustrates an example of a third logic flow 530 to determine contextual search terms for received search terms. FIG. 5B illustrates an example of a logic flow 530 that may be representative of some or all of the operations executed by one or more embodiments described herein.

At block 535, the logic flow 530 includes receiving, via one or more network links, a search query comprising a search term, the search query to cause performance of a search within a website.

The logic flow 530 includes, at block 540, determining a plurality of rules associated with the search term is met enabling a between link the search term with a plurality of contextual search terms, each of the plurality of rules comprising one or more criteria.

At block 545, the logic flow 530 includes causing presentation of the contextual search terms in an area of the website. For example, a server may communicate information to a computing device including a display to present to a user whom submitted the search query. A user may then be able to select, via an input device, one or more of the contextual search terms to utilize to perform the search, for example.

At block 550, the logic flow 530 includes receiving an indication of a selection of a contextual search term of the contextual search terms. Further and at block 555, the logic flow 530 includes appending the contextual search term with the search term in the search query to perform the search within the website.

At block 560, the logic flow 530 includes performing the search utilizing the search query comprising the search term and the contextual search term. At block 565, the logic flow includes sending a result, via the one or more network links, to the website.

FIG. 5C illustrates an example of a fourth logic flow 570 to determine contextual search terms for received search terms. FIG. 5C illustrates an example of a logic flow 570 that may be representative of some or all of the operations executed by one or more embodiments described herein.

At block 573, the logic flow 570 includes determining a first term of a search query entered via a website, the search query to cause performance of a search within a website. Further and at block 575, the logic flow 570 includes determining whether a rule comprising one or more criteria is met, the rule to associate the first term with a second term if the one or more criteria are met.

In embodiments, the logic flow 570, at block 578 includes appending the second term with the first term for the search query to perform the search within the website in response to determining the one or more criteria of the rule is met and/or at block 580 includes forgoing appending the second term with the first term for the search query to perform the search. In embodiments, the logic flow 570 includes performing the search within the website at block 583 and returning a result to the search query at block 585.

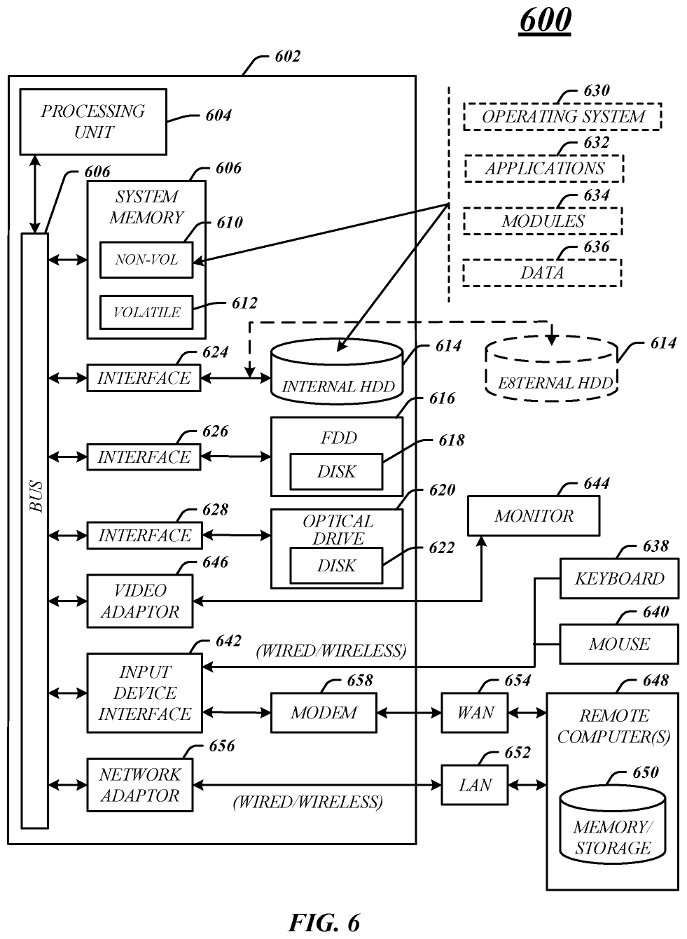

FIG. 6 illustrates an embodiment of an exemplary computing architecture 600 suitable for implementing various embodiments as previously described. In one embodiment, the computing architecture 600 may include or be implemented as part of system 100.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal.

Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 includes a processing unit 604, a system memory 606 and a system bus 608. The processing unit 604 can be any of various commercially available processors.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the system 700.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 604 through an input device interface 642 that is coupled to the system bus 608 but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654 or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 602 family of standards, such as wireless devices operatively disposed in wireless communication (e.g., IEEE 602.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 602.118 (a, b, g, n, etc.) to provide secure, reliable, fast wireless connectivity. A Wi-Fi network can be used to connect computers to each other, to the Internet, and to wire networks (which use IEEE 602.3-related media and functions).

The various elements of the devices as previously described with reference to FIGS. 1-5 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

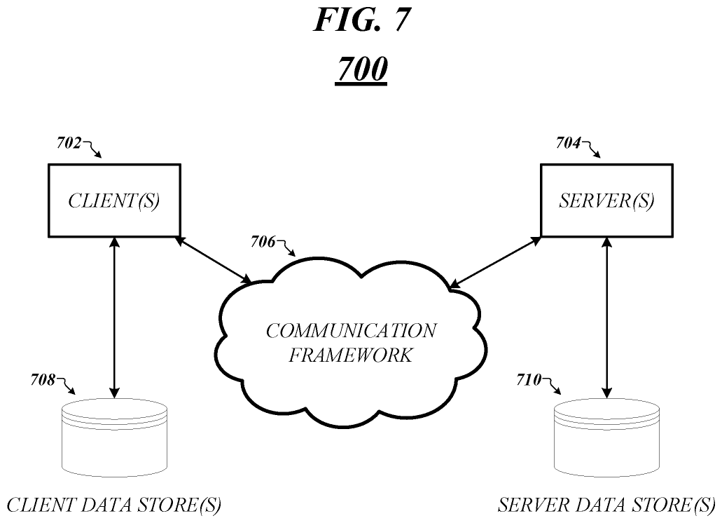

FIG. 7 is a block diagram depicting an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700, which may be consistent with system 100.

As shown in FIG. 7, the communications architecture 700 includes one or more clients 702 and servers 704. The servers 704 may implement the server device 526. The clients 702 and the servers 704 are operatively connected to one or more respective client data stores 706 and server data stores 707 that can be employed to store information local to the respective clients 702 and servers 704, such as cookies and/or associated contextual information.

The clients 702 and the servers 704 may communicate information between each other using a communication framework 710. The communications framework 710 may implement any well-known communications techniques and protocols. The communications framework 710 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 710 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 702.7a-x network interfaces, IEEE 702.16 network interfaces, IEEE 702.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

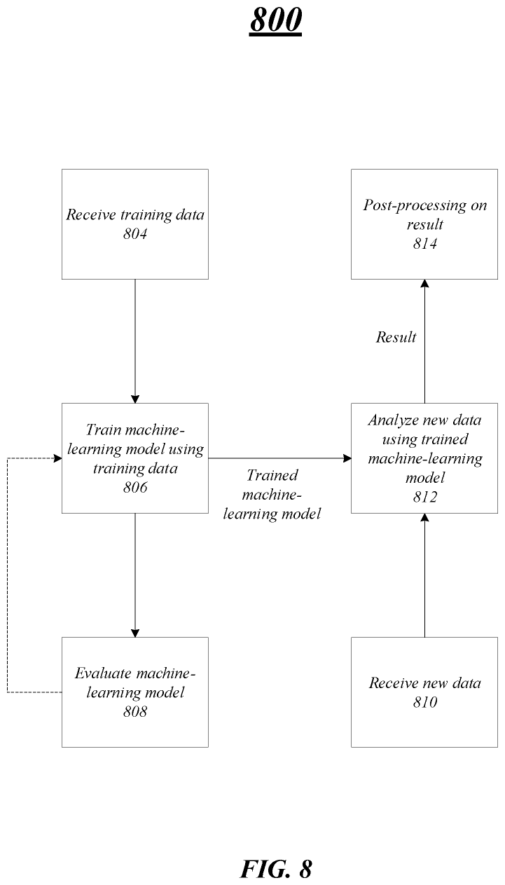

FIG. 8 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance. In one specific example, machine-learning models may be applied to perform operations and tasks as discussed herein, e.g., determine contextual search terms, determine rules, etc.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 8.

In block 804, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model. In embodiments, the training data may include information relating to a user account, transaction information, historical information, and so forth. The transaction information may be for a general population and/or specific to a user and user account in a financial institutional database system, for example.

In block 806, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model must find structure in the inputs on its own. In semi-supervised training, only some of the inputs in the training data are correlated to desired outputs.

In block 808, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, e.g., the current transaction information, the machine-learning model may have a high degree of accuracy. Otherwise, the machine-learning model may have a low degree of accuracy. The 90% number is an example only. A realistic and desirable accuracy percentage is dependent on the problem and the data.

In some examples, if the machine-learning model has an inadequate degree of accuracy for a particular task, the process can return to block 806, where the machine-learning model can be further trained using additional training data or otherwise modified to improve accuracy. If the machine-learning model has an adequate degree of accuracy for the particular task, the process can continue to block 810.

In block 810, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 812, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 814, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system, comprising:
a memory to store instructions; and
processing circuitry, coupled with the memory, operable to execute the instructions, that when executed, cause the processing circuitry to:
receive, via one or more network links, a search query associated with a user account, the search query comprising a search term, and to cause performance of a search within a web site;
submit a query to a dictionary database stored on a storage system, the query comprising the search term;
determine, from the dictionary database stored on the storage system, one or more contextual search terms related to the search term based on the query comprising the search term;
determine one or more rules associated with the user account, the one or more rules generated based on a trained machine-learning operation, each of the one or more rules comprising one or more criteria for the user account that when met link one of the one or more contextual search terms with the search term;
determine one or more criteria of a rule of the one or more rules is met based on information in the user account, the rule including the one or more criteria to cause a link between the search term with a contextual search term associated with the rule;
append the contextual search term with the search term in the search query to perform the search within the web site, wherein the contextual search term is appended to the search term when the one or more criteria of the rule are met;
perform the search within the web site utilizing the search query comprising the search term and the contextual search term appended with the search term;
determine a result of the search utilizing the search query comprising the search term and the contextual search term; and
communicate the result, via the one or more network link and in response to the search, to the website.

2. (canceled)

3. (canceled)

4. The system of claim 1, wherein the user account is one of a plurality of user accounts and each user account of the plurality of user account is associated with corresponding rules.

5. The system of claim 1, the processing circuitry to:
cause presentation of the contextual search term in an area of the website prior to appending the contextual search term; and
receive an indication of a selection of the contextual search term based on a user interaction with the website.

6. The system of claim 1, the processing circuitry to perform a crawl operation on the website to detect contextual search terms for search terms.

7. The system of claim 6, wherein the crawl operation includes applying natural language processing to each webpage of the website.

8. The system of claim 1, comprising:
a network interface coupled with the one or more network links; and
the storage system to store a plurality of user accounts, a plurality of rules including the rule, a plurality of search terms including the search term, and a plurality of contextual search terms including the contextual search term.

9. A computer-implemented method, comprising:
receiving, via one or more network links, a search query associated with a user account, the search query comprising a search term, and to cause performance of a search within a web site;
querying to a dictionary database stored on a storage system utilizing the search term;
determining, from the dictionary database stored on the storage system, contextual search terms associated with the search term;
determining a plurality of rules associated with the search term are met establishing links between the search term and the plurality contextual search terms, each of the plurality of rules comprising one or more criteria;
causing presentation of each of the plurality of contextual search terms in an area of the web site;
receiving an indication of a selection of a contextual search term of the plurality contextual search terms;
appending the contextual search term with the search term in the search query to perform the search within the web site;
performing the search utilizing the search query comprising the search term and the contextual search term; and
sending a result, via the one or more network links and in response to the search utilizing the search query, to the website.

10. The computer-implemented method of claim 9, comprising:
determining the plurality of rules associated with the user account to determine whether criteria are met.

11. The computer-implemented method of claim 10, comprising performing the machine learning to determine the plurality of rules associated with the user account, each of the plurality of rules comprising one or more criteria that when met link a term with another term.

12. The computer-implemented method of claim 10, wherein the user account is one of a plurality of user accounts, and each user account of the plurality of user account is associated with corresponding rules.

13. The computer-implemented method of claim 9, comprising performing a crawl operation on the website to detect contextual search terms for search terms.

14. The computer-implemented method of claim 13, wherein the crawl operation includes applying natural language processing to each webpage of the website.

15. The computer-implemented method of claim 9, comprising storing a plurality of user accounts, the plurality of rules, a plurality of search terms including the search term, and a plurality of contextual search terms including the contextual search term in a storage system.

16. A computer-readable storage medium storing computer-readable program code executable by a processor to:
determine a first term of a search query entered via a web site, the search query to cause performance of a search within a web site;
determine a user account associated with the search query;
perform machine learning to determine a plurality of rules associated with the user account;
determine whether a rule of the plurality of rules comprising one or more criteria is met, the rule to associate the first term with a second term if the one or more criteria are met, and wherein the second term is related to the first term in a database stored in storage;
append the second term with the first term for the search query to perform the search within the website in response to determining the one or more criteria of the rule is met;
forgo appending the second term with the first term for the search query to perform the search;
perform the search on the web site; and
return a result, via the one or more network links, to the search query.

17. (canceled)

18. The computer-readable storage medium of claim 16, each of the plurality of rules comprising one or more criteria that when met link a term with the first term, and wherein the user account is one of a plurality of user accounts and each user account of the plurality of user account is associated with corresponding rules.

19. The computer-readable storage medium of claim 16, further comprising computer-readable program code executable to:
cause presentation of the second term in an area of the web site prior to appending the second term; and
receive an indication of a selection of the second term based on a user interaction with the web site.

20. The computer-readable storage medium of claim 16, further comprising computer-readable program code executable to perform a crawl operation on the website to detect contextual search terms for search terms, wherein the crawl operation includes applying natural language processing to each webpage of the website.
